(19) United States
(12) Patent Application Publication
(10) Pub. No.: US 2026/0331780 A1
(43) Pub. Date: Oct. 22, 2026

(54) METASURFACE UNIT AND METASURFACE

(71) Applicant: BEIJING XIAOMI MOBILE SOFTWARE CO., LTD., Beijing (CN)

(72) Inventors: Liangang CHI, Beijing (CN); Dong CHEN, Beijing (CN)

(73) Assignee: BEIJING XIAOMI MOBILE SOFTWARE CO., LTD., Beijing (CN)

(21) Appl. No.: 19/123,039

(22) PCT Filed: Oct. 21, 2022
(86) PCT No.: PCT/CN2022/126842

§ 371 Date: Apr. 21, 2025

(51) Int. Cl. H01Q 15/14; H01Q 15/00

(52) U.S. Cl. CPC H01Q 15/145; H01Q 15/0086; H01Q 15/148

(57) ABSTRACT

The present disclosure provides a metasurface unit and a metasurface. The metasurface unit includes: a metal ground layer; a liquid crystal layer disposed on the metal ground layer; and one or more metal patches disposed on a side of the liquid crystal layer away from the metal ground layer and connected to a power supply via a bias line. The one or more metal patches are rectangular, and have long sides extending in the same direction.

### CROSS-REFERENCE TO RELATED APPLICATIONS

This disclosure is the U.S. national phase of PCT Application No. PCT/CN2022/126842 filed on Oct. 21, 2022, the disclosure of which is incorporated herein by reference in its entirety for all purposes.

### TECHNICAL FIELD

This disclosure relates to the field of metasurface technology, and in particular to a metasurface unit and a metasurface.

### BACKGROUND

Metasurface is a new technology that has emerged in recent years, and is formed by metasurface units arranged in a periodic or aperiodic manner. Metasurface, as the two-dimensional form of metamaterial, plays an increasingly important role in various scientific fields, such as electromagnetics, optics, acoustics, and thermodynamics. Since liquid crystal is a common tunable material in the millimeter-wave band, and has the characteristics of relatively small dielectric loss and optical transparency, the liquid crystal material is usually added into the metasurface to adjust the phase and/or amplitude of the metasurface.

In the related art, the metasurface unit in the liquid crystal-tunable metasurface employs an anisotropic structure, and has two polarization directions which operates in two frequency bands, respectively. The phase response of the metasurface unit in the different polarization directions is changed by adjusting the dielectric constant of the liquid crystal material in the metasurface unit, such that the metasurface with the dual-band operation capability is constructed.

However, in the related art, since the metasurface unit has two different polarization directions which operates in two frequency bands, respectively, cross-polarization may occur, which may affect the reflection quality of the metasurface and occupy cross-polarization resources.

### SUMMARY

The present disclosure provides a metasurface unit and a metasurface, which is a liquid crystal-tunable reflective metasurface operating with single-polarization and dual-band in millimeter-wave band, such that cross-polarization may be avoided, the reflection quality of the metasurface may be ensured, and cross-polarization resources may not be occupied.

In a first aspect, examples of the present disclosure provide a metasurface unit, including:
a metal ground layer;
a liquid crystal layer disposed on the metal ground layer; and
one or more metal patches disposed on a side of the liquid crystal layer away from the metal ground layer and connected to a power supply via a bias line, where the one or more metal patches are rectangular, and have long sides extending in a same direction.

With the metasurface unit according to the present disclosure, one or more rectangular metal patches have long sides extending in a same direction, such that the metasurface unit has a single polarization direction, which can prevent cross-polarization, ensure the reflection quality of the metasurface, and avoid occupying cross-polarization resources. In the present disclosure, the one or more rectangular metal patches have different sizes, such that the metasurface unit has a multi-band operation capability. Meanwhile, in the present disclosure, the metasurface unit is formed by using a liquid crystal layer as a tunable material, such that the reflection and/or scattering amplitude and the reflection and/or scattering phase of the metasurface unit are continuously tunable, which improves the flexibility of tuning the reflection and/or scattering amplitude and the reflection and/or scattering phase of the metasurface unit. In addition, due to the relatively small insertion loss and the relatively high practical applicability of the liquid crystal, when the liquid crystal is used as the tunable material, the operating frequency band of the metasurface unit can reach a millimeter-wave or even a terahertz band, such that the operating frequency band of the metasurface unit is expanded.

In a second aspect, embodiments of the present disclosure provide a metasurface including:
one or more metasurface units as described above in the first aspect.

### BRIEF DESCRIPTION OF DRAWINGS

The foregoing and/or additional aspects and advantage of the present disclosure will become apparent and readily appreciated from the following description of embodiments taken in conjunction with the accompany drawings in which:

FIG. 1 is a schematic top view of a metasurface unit according to examples of the present disclosure;

FIG. 2 is a schematic side view of a metasurface unit according to examples of the present disclosure;

FIG. 3 is a schematic diagram illustrating changes in reflection and/or scattering amplitude and reflection and/or scattering phase of a metasurface unit according to examples of the present disclosure at different frequencies of incident wave beams, when a liquid crystal layer 5 in the metasurface unit has different dielectric constants;

FIG. 4 is a two-dimensional far-field pattern of a metasurface at different phase periods when a frequency of an incident wave beam is 23.1 GHz; and

FIG. 5 is a two-dimensional far-field pattern of a metasurface at different phase periods when a frequency of an incident wave beam is 29.8 GHz.

### DETAILED DESCRIPTION

Reference will now be made in detail to exemplary embodiments, examples of which are illustrated in the accompanying drawings. When the following description refers to the drawings, the same numerals in different drawings indicate the same or similar elements, unless otherwise indicated. Embodiments described in the following exemplary embodiments are not intended to be representative of all of the embodiments consistent with the present disclosure. Rather, they are merely examples of apparatuses and methods consistent with some aspects of the disclosed embodiments as detailed in the appended claims.

Terminology used in the embodiments of the present disclosure is for the purpose of describing particular embodiments only and is not intended to be limiting of the embodiments of the disclosure. As used in the embodiments of the present disclosure and the append claims, the singular forms “a”, “an”, and “the” are intended to include the plural form as well, unless the context clearly dictates otherwise. It should also be understood that the term “and/or” as used herein refers to and encompasses any or all possible combinations of one or more of the associated listed items.

It should be understood that although terms first, second, third, etc. may be used in the embodiments of the present disclosure to describe various information, such information should not be limited by these terms. These terms are used only to distinguish the same type of information from one another. For example, the first information may also be referred to as the second information, and similarly, the second information may also be referred to as the first information, without departing from the scope of the embodiments of the present disclosure. Depending on the context, the word “if” as used herein may be interpreted as “when . . . ” or “upon . . . ” or “in response to determining”.

Embodiments of the present disclosure will be described in detail below, examples of which are illustrated in the accompanying drawings in which like or similar reference numerals refer to like or similar elements throughout. The embodiments described below with reference to the drawings are exemplary, and are intended to be illustrative of the present disclosure and are not to be construed as limiting the present disclosure.

For ease of understanding, terminology involved in the present application will be described first.

### 1. Metasurface

A metasurface refers to an artificial layered material with a thickness less than a wavelength. The metasurface enables flexible and effective tuning of polarization, amplitude, phase, polarization mode, propagation mode, and other characteristics of an electromagnetic wave. The metasurface can be regarded as a two-dimensional counterpart of a metamaterial.

A metasurface unit and a metasurface according to examples of the present disclosure will be described in detail below with reference to the accompanying drawings.

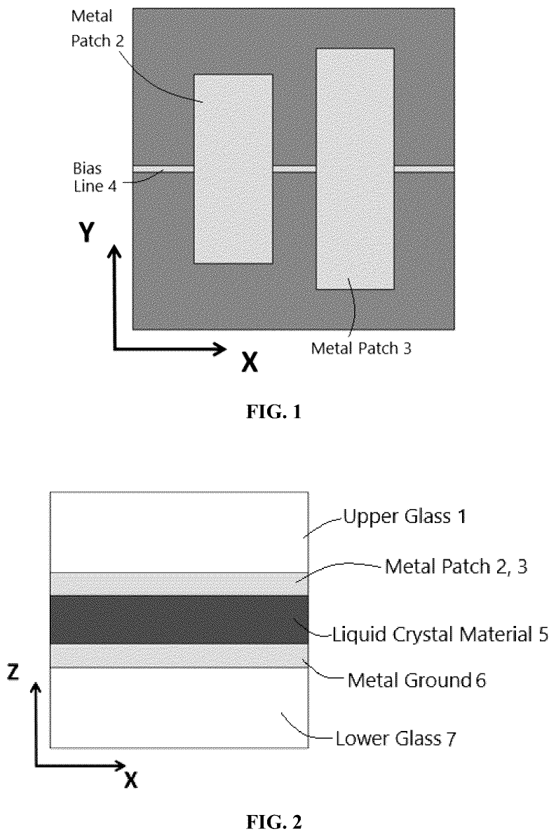

FIG. 1 is a schematic top view of a metasurface unit according to examples of the present disclosure, and FIG. 2 is a schematic side view of a metasurface unit according to examples of the present disclosure. As shown in FIGS. 1 and 2, the metasurface unit may include:
a metal ground layer 6, i.e., a metal ground 6 as shown in FIGS. 1 and 2;
a liquid crystal layer 5, i.e., a liquid crystal material 5 as shown in FIGS. 1 and 2, disposed on the metal ground layer 6; and
one or more metal patches (in FIGS. 1 and 2, a metal patch 2 and a metal patch 3 are provided as an example for illustration purposes), disposed on a side of the liquid crystal layer 5 away from the metal ground layer 6 and connected to a power supply via a bias line 4, where the one or more metal patches are rectangular, and have long sides extending in the same direction. For example, referring to FIGS. 1 and 2, the metal patches 2 and 3 have long sides both extending in Y direction.

In an example of the present disclosure, the metal ground layer 6 and the one or more metal patches may be used as a reflector and/or scatterer of the metasurface unit to reflect and/or scatter an incident wave beam.

It should be noted that when the metal patch is rectangular, a polarization direction of the metal patch when reflecting and/or scattering the beam is related to a direction in which a long side of the metal patch extends. On the basis of this, in an example of the present disclosure, the one or more metal patches have long sides extending in the same direction, such that the polarization direction of the metasurface unit is a single polarization direction, which can avoid cross-polarization, ensure the reflection quality of the metasurface, and avoid occupying cross-polarization resources.

In an example of the present disclosure, when the metal patches have different sizes, the operating frequency bands of the metal patches when reflecting and/or scattering incident wave beams are different. The operating frequency band of the metal patch may be understood as a frequency band of the wave beam that can be reflected and/or scattered by the metal patch. For example, if the operating frequency band of the metal patch is 10 GHz to 20 GHz, the wave beam that can be reflected and/or scattered by the metal patch is a wave beam with a frequency between 10 GHz and 20 GHz. In other words, the metal patch is mainly used for reflecting and/or scattering an incident wave beam with a frequency belonging to the operating frequency band corresponding to the metal patch.

On the basis of this, in an example of the present disclosure, different metal patches in the metasurface unit have different sizes, such that the metasurface unit has a multi-band operation capability, i.e., a multi-band reflection and/or scattering capability. Different sizes of the different metal patches may indicate different lengths of the different metal patches and/or different widths of the different metal patches, which in turn may indicate different areas of the different metal patches.

In the present disclosure, a metasurface unit including two metal patches will be mainly illustrated as an example. The two metal patches may include a first metal patch (i.e., the metal patch 2 in FIGS. 1 and 2) and a second metal patch (i.e., the metal patch 3 in FIGS. 1 and 2), where the first metal patch and the second metal patch are arranged side by side, that is, an extension direction of a long side of the first metal patch is the same as that of a long side of the second metal patch, and a size of the first metal patch is different from that of the second metal patch, such that a single-polarization dual-band reflective metasurface unit can be constructed.

Further, in an example of the present disclosure, the metasurface unit may further include:
a first substrate disposed on a side of the metal ground layer 6 away from the liquid crystal layer 5; and
a second substrate disposed on a side of the one or more metal patches away from the liquid crystal layer 5.

The first substrate and the second substrate can provide adhesion and support for other layers so as to constrain the flow of liquid crystals, and can also be used for encapsulating the liquid crystal material. And, both the first substrate and the second substrate may be made of glass. Referring to FIG. 2, the first substrate may be a lower glass 7 in FIG. 2, and the second substrate may be an upper glass 1 in FIG. 2. The first substrate and the second substrate may be made of BF33. However, substrates made of other materials are also possible.

In an example of the present disclosure, the one or more metal patches may be made of the same metal material, such as copper or silver.

The foregoing is a description of the structure of the metasurface unit in the present disclosure. As can be seen from the foregoing, the metasurface unit in the present disclosure is mainly a single-polarization multi-band metasurface unit. However, at the same time, the metasurface unit in the present disclosure also has continuous tunability, which will be described below.

In an example of the present disclosure, the liquid crystal layer in the metasurface unit may be used as a tunable material to tune the reflection and/or scattering amplitude and the reflection and/or scattering phase of the metasurface unit, and the reflection and/or scattering amplitude and the reflection and/or scattering phase of the metasurface unit are continuously tunable based on the liquid crystal layer in the present disclosure.

In particular, in an example of the present disclosure, the metal ground layer 6 may also serve as a negative electrode for a DC bias, and the one or more metal patches may serve as a positive electrode for the DC bias. On the basis of this, by adjusting the voltage of the power supply to which the bias line 4 is connected, the voltage output to the metal patches can be changed, resulting in a change in the voltage drop across the liquid crystal layer 5, and in turn a change in the dielectric constant of the liquid crystal layer 5. Moreover, in an example of the present disclosure, when the dielectric constant of the liquid crystal layer 5 is changed, the reflection and/or scattering amplitude and the reflection and/or scattering phase of the metal patches and the metal ground when reflecting and/or scattering the incident wave beam are changed, enabling the tunability of the reflection and/or scattering amplitude and the reflection and/or scattering phase of the metasurface unit.

It should be noted that, in the present disclosure, when the dielectric constant of the liquid crystal layer 5 is adjusted by adjusting the voltage of the power supply, the dielectric constant of the liquid crystal layer 5 is continuously adjustable. Here, “continuously adjustable” can be understood to mean that the dielectric constant of the liquid crystal layer 5 can be continuously and non-discretely adjusted from a certain value to another value. On the basis of this, since the dielectric constant of the liquid crystal layer 5 is continuously adjustable, the reflection and/or scattering amplitude and the reflection and/or scattering phase of the metasurface unit can be continuously tunable.

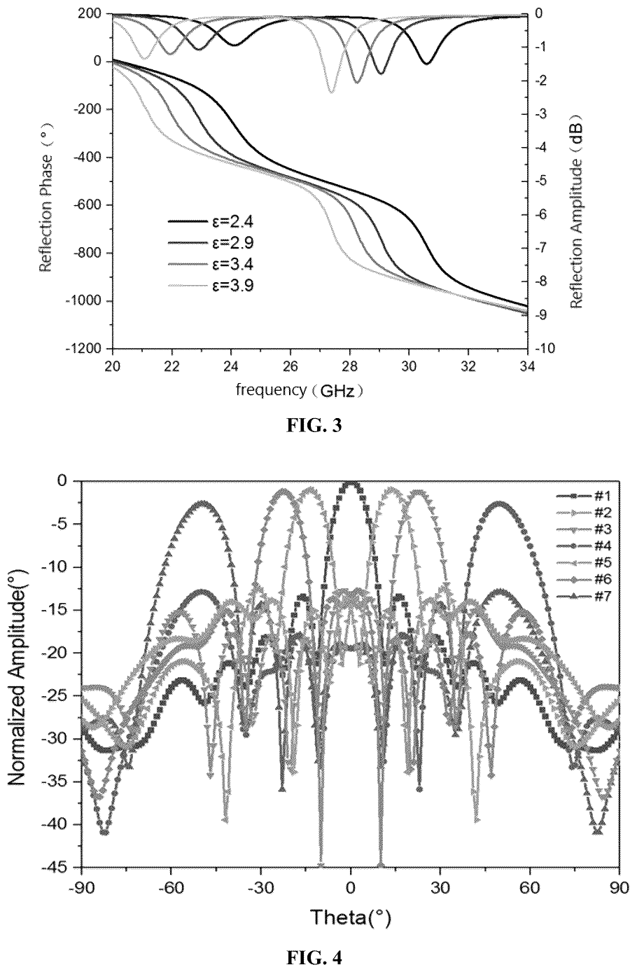

As can be seen from the above, in the present disclosure, the reflection and/or scattering amplitude and the reflection and/or scattering phase of the metasurface unit to the incident wave beam are related to the dielectric constant of the liquid crystal layer. The dielectric constant of the liquid crystal layer is related to the voltage of the power supply. Therefore, the dielectric constant of the liquid crystal layer in the metasurface unit is changed by adjusting the voltage of the power supply, such that the reflection and/or scattering amplitude and the reflection and/or scattering phase of the metasurface unit can be continuously adjusted. FIG. 3 is a schematic diagram illustrating changes in reflection and/or scattering amplitude and reflection and/or scattering phase of a metasurface unit according to examples of the present disclosure at different frequencies of incident wave beams, when a liquid crystal layer 5 in the metasurface unit has different dielectric constants. FIG. 3 illustrates an example in which the dielectric constant ε of the liquid crystal layer 5 in the metasurface unit is 2.4, 2.9, 3.4 and 3.9, respectively.

The upper four curves in FIG. 3 illustrate changes in the reflection amplitude of the metasurface unit at different frequencies of incident wave beams, when the dielectric constant ε of the liquid crystal layer 5 in the metasurface unit is 2.4, 2.9, 3.4 and 3.9, respectively. Referring to FIG. 3, when the dielectric constant ε of the liquid crystal layer 5 in the metasurface unit is 2.4, 2.9, 3.4 and 3.9, the reflection amplitude of the metasurface unit is less than −2 dB at both the frequencies of the incident wave beams of 23.1 GHz and 29.8 GHz, enabling low reflection loss and high reflection accuracy.

The lower four curves in FIG. 3 illustrate changes in the reflection phase of the metasurface unit at different frequencies of incident wave beams, when the dielectric constant ε of the liquid crystal layer 5 in the metasurface unit is 2.4, 2.9, 3.4 and 3.9, respectively. Referring to FIG. 3, at the frequencies of the incident wave beams of 23.1 GHz and 29.8 GHz, the change in the reflection phase of the metasurface unit covers 270° as the dielectric constant of the liquid crystal layer 5 changes.

As can be seen from the above, when the liquid crystal layer is used as a tunable material to form the metasurface unit, the reflection and/or scattering amplitude and the reflection and/or scattering phase of the metasurface unit are continuously tunable, which improves the flexibility of tuning the reflection and/or scattering amplitude and the reflection and/or scattering phase of the metasurface unit. Meanwhile, due to the relatively small insertion loss and the relatively high practical applicability of the liquid crystal, when the liquid crystal is used as the tunable material, the operating frequency band of the metasurface unit can reach a millimeter-wave or even a terahertz band, such that the operating frequency band of the metasurface unit is expanded.

As above, the metasurface unit according to the present disclosure has the following characteristics.

The reflection and/or scattering amplitude and the reflection and/or scattering phase of the metasurface unit are continuously tunable, which can improve the flexibility of tuning the reflection and/or scattering amplitude and the reflection and/or scattering phase of the metasurface unit.

The metasurface unit has a single polarization direction, which can prevent cross-polarization, ensure the reflection quality of the metasurface, and avoid occupying cross-polarization resources.

The metasurface unit has a multi-band operation capability.

The operating frequency band of the metasurface unit can reach a millimeter-wave or even a terahertz band, such that the operating frequency band of the metasurface unit is expanded.

Therefore, the present disclosure provides a liquid crystal-tunable reflective metasurface unit operating with single-polarization and multi-band (e.g., dual-band) in millimeter-wave band.

To sum up, a metasurface unit according to the present disclosure includes: a metal ground layer; a liquid crystal layer disposed on the metal ground layer; and one or more metal patches disposed on a side of the liquid crystal layer away from the metal ground layer and connected to a power supply via a bias line, where the one or more metal patches are rectangular, and have long sides extending in a same direction. With the metasurface unit according to the present disclosure, one or more rectangular metal patches have long sides extending in a same direction, such that the metasurface unit has a single polarization direction, which can prevent cross-polarization, ensure the reflection quality of the metasurface, and avoid occupying cross-polarization resources. In the present disclosure, the one or more rectangular metal patches have different sizes, such that the metasurface unit has a multi-band operation capability. Meanwhile, in the present disclosure, the metasurface unit is formed by using a liquid crystal layer as a tunable material, such that the reflection and/or scattering amplitude and the reflection and/or scattering phase of the metasurface unit are continuously tunable, which improves the flexibility of tuning the reflection and/or scattering amplitude and the reflection and/or scattering phase of the metasurface unit. In addition, due to the relatively small insertion loss and the relatively high practical applicability of the liquid crystal, when the liquid crystal is used as the tunable material, the operating frequency band of the metasurface unit can reach a millimeter-wave or even a terahertz band, such that the operating frequency band of the metasurface unit is expanded.

In addition, it should be noted that the thicknesses of the liquid crystal layer, the metal ground layer, the metal patches, the first substrate, and the second substrate in the metasurface unit can be adaptively changed, where when the thicknesses of the liquid crystal layer, the metal ground layer, the metal patches, the first substrate, and the second substrate are changed, the reflection and/or scattering amplitude and the reflection and/or scattering phase of the metasurface unit may be changed accordingly.

The present disclosure further provides a metasurface, including one or more metasurface units as shown above in FIGS. 1 and 2. In an example of the present disclosure, the metasurface may include metasurface units arranged periodically or aperiodically. For example, in an example of the present disclosure, the metasurface may include metasurface units arranged periodically, for example, in a matrix. In this case, the metasurface may include m×n metasurface units, where m represents a row, n represents a column, and both m and n are positive integers. It should be understood, however, that other possible arrangements are within the scope of protection of the present disclosure, and are not limited in the present disclosure.

It should be noted that, in an example of the present disclosure, wave beams reflected and/or scattered by the metasurface are formed under combined action of all or part of the metasurface units in the metasurface. The “combined action of all or part of the metasurface units” can be understood as combined reflection and/or scattering of incident wave beams by all or part of the metasurface units. Based on this, it can be determined that the deflection angle of the wave beam reflected and/or scattered by the metasurface is mainly related to the reflection and/or scattering amplitudes and the reflection and/or scattering phases of all or part of the metasurface units, in other words, the deflection angle of the wave beam reflected and/or scattered by the metasurface is particularly related to the phase period of the metasurface. The phase period of the metasurface can be understood as that the reflection and/or scattering amplitude and the reflection and/or scattering phase of the metasurface unit in the metasurface are changed periodically by adjusting the dielectric constant of the liquid crystal layer in the metasurface unit to different values.

An example will be provided to illustrate the phase period. The metasurface is assumed to include 1×4 metasurface units, which are metasurface unit #a, metasurface unit #b, metasurface unit #c, and metasurface unit #d. When the dielectric constants of the liquid crystal layers in the metasurface unit #a, the metasurface unit #b, the metasurface unit #c, and the metasurface unit #d are adjusted to be a first value, a second value, the first value, and the second value, respectively, the same dielectric constant is periodically taken in all of the metasurface units with two metasurface units as a granularity, that is, the reflection and/or scattering amplitude and the reflection and/or scattering phase are periodically changed with two metasurface units as a granularity, at which time the phase period of the metasurface is 2. Similarly, the dielectric constants of the liquid crystal layers in the metasurface unit #a, the metasurface unit #b, the metasurface unit #c, and the metasurface unit #d are all adjusted to be the first value, at which time the phase period of the metasurface is 1. The dielectric constants of the liquid crystal layers in the metasurface unit #a, the metasurface unit #b, the metasurface unit #c, and the metasurface unit #d are adjusted to be a first value, a second value, a third value, and a fourth value, respectively, at which time the phase period of the metasurface is 4.

As can be seen from the above, the phase period of the metasurface may affect the reflection and/or scattering amplitudes and the reflection and/or scattering phases of the metasurface units, which in turn affects the deflection angle of the wave beam reflected and/or scattered by the metasurface, i.e., the deflection angle of the wave beam reflected and/or scattered by the metasurface is related to the phase period of the metasurface, and the phase period of the metasurface is related to the dielectric constant. Based on this, the phase period of the metasurface can be adjusted by adjusting the dielectric constants of the liquid crystal layers in different metasurface units of the metasurface, and in turn the deflection angle of the wave beam reflected and/or scattered by the metasurface can be adjusted, so as to realize different beam adjustment functions. It should be noted that on the premise that the dielectric constant of the liquid crystal layer is continuously adjustable, the deflection angle of the wave beam reflected and/or scattered by the metasurface should be continuously adjustable.

Further, it should be noted that, in an example of the present disclosure, the dielectric constants of the liquid crystal layers in the metasurface units can be adjusted with the same column or row of the metasurface units as a granularity. For example, by adjusting the dielectric constants of the liquid crystal layers in the same column of the metasurface units to be the same, and adjusting the dielectric constants of the liquid crystal layers in different columns of the metasurface units to be different or the same, the phase period of the metasurface can be adjusted. Alternatively, by adjusting the dielectric constants of the liquid crystal layers in the same row of the metasurface units to be the same, and adjusting the dielectric constants of the liquid crystal layers in different rows of the metasurface units to be different or the same, the phase period of the metasurface can be adjusted. In this way, the complexity of the feed network can be reduced.

Based on this, two-dimensional far-field patterns of a metasurface at different phase periods will be described below with frequencies of incident wave beams being 23.1 GHz (low frequency) and 29.8 GHz (high frequency), for example.

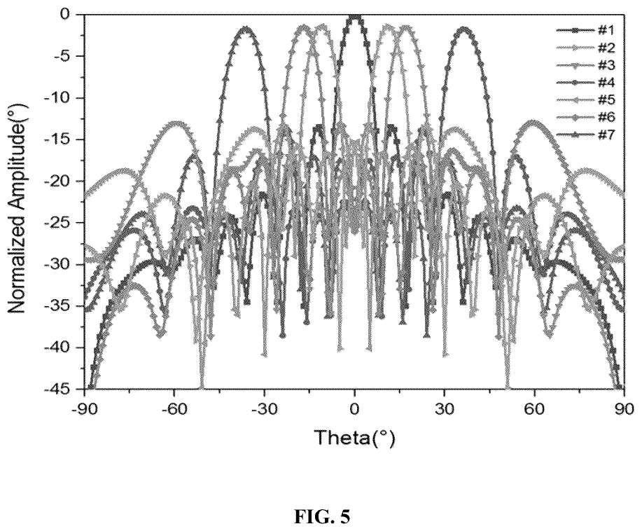

For example, the metasurface is assumed to include m×16 metasurface units, where the dielectric constants of the liquid crystal layers in the metasurface units are adjusted with an entire column of the metasurface units as a granularity. That is, the dielectric constants of the liquid crystal layers in the same column of the metasurface units are the same. Based on this, FIG. 4 is a two-dimensional far-field pattern of a metasurface at different phase periods when a frequency of an incident wave beam is 23.1 GHz; and FIG. 5 is a two-dimensional far-field pattern of a metasurface at different phase periods when a frequency of an incident wave beam is 29.8 GHz.

#1 in FIG. 4 and FIG. 5 indicates a phase period of the metasurface units arranged in 1111111111111111, which can be understood as that the liquid crystal layers in the first column to the sixteenth column of the metasurface units of the metasurface have the same dielectric constant ε of 2.4, thereby the phase period is 1. Here, the metasurface units with the dielectric constant ε of 2.4 may be named as metasurface units 1.

#2 in FIG. 4 indicates a phase period of the metasurface units arranged in 1234123412341234, which can be understood as that the liquid crystal layers in the first column, the fifth column, the ninth column, and the thirteenth column of the metasurface units of the metasurface have the same dielectric constant ε of 2.4, the liquid crystal layers in the second column, the sixth column, the tenth column, and the fourteenth column of the metasurface units of the metasurface have the same dielectric constant ε of 2.93, the liquid crystal layers in the third column, the seventh column, the eleventh column, and the fifteenth column of the metasurface units of the metasurface have the same dielectric constant ε of 3.18, and the liquid crystal layers in the fourth column, the eighth column, the twelfth column, and the sixteenth column of the metasurface units of the metasurface have the same dielectric constant ε of 3.8, thereby the phase period is 4. Here, the metasurface units with the dielectric constant ε of 2.4 may be named as metasurface units 1, the metasurface units with the dielectric constant ε of 2.93 may be named as metasurface units 2, the metasurface units with the dielectric constant ε of 3.18 may be named as metasurface units 3, and the metasurface units with the dielectric constant ε of 3.8 may be named as metasurface units 4.

#2 in FIG. 5 indicates a phase period of the metasurface units arranged in 1234123412341234, which can be understood as that the liquid crystal layers in the first column, the fifth column, the ninth column, and the thirteenth column of the metasurface units of the metasurface have the same dielectric constant ε of 2.4, the liquid crystal layers in the second column, the sixth column, the tenth column, and the fourteenth column of the metasurface units of the metasurface have the same dielectric constant ε of 2.72, the liquid crystal layers in the third column, the seventh column, the eleventh column, and the fifteenth column of the metasurface units of the metasurface have the same dielectric constant ε of 2.88, and the liquid crystal layers in the fourth column, the eighth column, the twelfth column, and the sixteenth column of the metasurface units of the metasurface have the same dielectric constant ε of 3.5, thereby the phase period is also 4. Here, the metasurface units with the dielectric constant ε of 2.4 may be named as metasurface units 1, the metasurface units with the dielectric constant ε of 2.72 may be named as metasurface units 2, the metasurface units with the dielectric constant ε of 2.88 may be named as metasurface units 3, and the metasurface units with the dielectric constant ε of 3.5 may be named as metasurface units 4.

#3 in FIG. 4 and FIG. 5 indicates a phase period of the metasurface units arranged in 1122334411223344, and the phase period is 8. #4 in FIG. 4 and FIG. 5 indicates a phase period of the metasurface units arranged in 1112223334441112, and the phase period is 12. #5 in FIG. 4 and FIG. 5 indicates a phase period of the metasurface units arranged in 4321432143214321, and the phase period is 4. #6 in FIG. 4 and FIG. 5 indicates a phase period of the metasurface units arranged in 4433221144332211, and the phase period is 8. #7 in FIG. 4 and FIG. 5 indicates a phase period of the metasurface units arranged in 2111444333222111, and the phase period is 12. The principles of the above-mentioned “arranged in 1122334411223344”, “arranged in 1112223334441112”, “arranged in 4321432143214321”, “arranged in 4433221144332211”, and “arranged in 2111444333222111” are similar to those of “arranged in 1111111111111111” and “arranged in 1234123412341234”, and will not be repeated herein.

“Theta” in FIGS. 4 and 5 represents the deflection angle of the reflected wave beam by the metasurface, and “Normalized Amplitude” in FIGS. 4 and 5 represents a normalized amplitude of the reflected wave beam by the metasurface.

As can be seen from FIG. 4, at the low frequency of 23.1 GHz, the deflection angle of the reflected wave beam by the metasurface with the phase period of #2 is 14°, and the deflection angle of the reflected wave beam by the metasurface with the phase period of #5 is −14°; and the deflection angle of the reflected wave beam by the metasurface with the phase period of #3 is 23°, and the deflection angle of the reflected wave beam by the metasurface with the phase period of #6is −23°. Referring to FIGS. 4 and 5, at the low frequency of 23.1 GHz, the wave beams are scanned to ±14°, ±23°, and ±50°, respectively, and at the high frequency of 29.8 GHz, the wave beams are scanned to ±11.6°, ±17°, and ±36.5°, respectively. At both frequency points, the beam scanning function is realized on the metasurface.

In summary, the present disclosure provides a reflective metasurface with a simple design, a low profile, and a dual-band operation capability, and suitable for millimetre-wave bands. The present disclosure constructs a liquid crystal-tunable reflective metasurface. A previous metasurface loaded with a diode can only operate in a lower microwave band, whereas when the liquid crystal is used as a tunable material, the metasurface can operate in a millimetre-wave or even a terahertz band. The present disclosure expands the operating frequency band of the metasurface. The present disclosure constructs a reflective metasurface based on a double-patch structure, in which two patches with different sizes respectively operate in two operating frequency bands to construct the metasurface with double-band operation capability. The liquid crystal-tunable reflective metasurface in the present disclosure has the characteristic of continuous tenability. The continuous tuning of the state of the metasurface unit can be realized by changing the voltage applied across the liquid crystal layer, which improves the flexibility of tuning.

Those skilled in the art may further appreciate that various illustrative logical blocks and steps in the examples of the present disclosure may be implemented as electronic hardware, computer software, or combinations of both. Whether such functionality is implemented as hardware or software depends on the particular application and overall system design requirements. Those skilled in the art may use various methods to implement the described functionality for each particular application, but such implementations should not be construed as going beyond the scope of protection of the examples of the present disclosure.

The above-described examples may be implemented in whole or in part by software, hardware, firmware, or any combination thereof. When implemented by software, the examples may be implemented in whole or in part in the form of a computer program product. The computer program product includes one or more computer programs. Such computer programs, when loaded and executed on a computer, result, in whole or in part, in the processes or functions described in accordance with examples of the present disclosure. The computer may be a general purpose computer, special purpose computer, computer network, or other programmable device. The computer program may be stored in a computer-readable storage medium or transmitted from one computer-readable storage medium to another computer-readable storage medium, for example, the computer program may be transmitted from a web site, computer, server, or data center via wired (e.g., coaxial cable, fiber optic, digital subscriber line (DSL)) or wireless (e.g., infrared, wireless, microwave, etc.) to another web site, compute, server, or data center. The computer-readable storage medium may be any available medium that can be accessed by a computer or an integrated data storage device such as a server, data center, or the like, that contains one or more available media. The available medium may be a magnetic medium (e.g., a floppy disk, a hard disk, a magnetic tape), an optical medium (e.g., a digital video disc (DVD)), or a semiconductor medium (e.g., a solid state disk (SSD)), among others.

Those ordinary skilled in the art can understand that the first, second and other numbers referred to in the present disclosure are only distinguished for the convenience of description, and are not used to limit the scope of the examples of the present disclosure, or represent the sequence.

“At least one” may also be described herein as “one or more”, and “a plurality of” may be two, three, four, or more, without limitation herein. In the examples of the present disclosure, for a type of technical features, the technical features are distinguished by “first”, “second”, “third”, “A”, “B”, “C”, “D”, etc. The technical features described by “first”, “second”, “third”, “A”, “B”, “C”, and “D” have no order of sequence or magnitude.

The correspondence shown in each table in the present disclosure may be configured or predefined. The value of the information in each table is only an example, and may be configured as other values, which is not limited by the present disclosure. When the correspondence between the information and each parameter is configured, it is not necessarily required to configure all the correspondence shown in each table. For example, in the table of the present disclosure, the correspondence shown in some rows may not be configured. For another example, appropriate modifications and adjustments can be made based on the above table, such as splitting, merging, and the like. The names of the parameters indicated by the titles in the above tables may also adopt other names that can be understood by the communication device, and the values or expressions of the parameters may also adopt other values or expressions that can be understood by the communication device. Other data structures, such as an array, a queue, a container, a stack, a linear list, a pointer, a linked list, a tree, a graph, a structure, a class, a heap, a hash table, or a hash table, may be used to implement each of the above tables.

Predefinition in the present disclosure may be understood as definition, pre-definition, storage, pre-storage, pre-negotiation, pre-configuration, curing, or pre-firing.

Those ordinary skilled in the art will appreciate that the elements and algorithm steps of the examples described in connection with the examples disclosed herein can be implemented as electronic hardware or a combination of computer software and electronic hardware. Whether these functions are implemented as hardware or software depends on the particular application and design constraints of the technical solution. Those skilled in the art may implement the described functionality using different methods for each particular application, but such implementations should not be considered as going beyond the scope of the present disclosure.

Those skilled in the art can clearly understand that, for the convenience and brevity of description, the specific operating processes of the systems, devices and units described above can be referred to the corresponding processes in the foregoing method examples, and are not described herein.

The above description is only a detailed description of the present disclosure, but the scope of protection of the present disclosure is not limited thereto. Any person skilled in the art may easily conceive of changes or substitutions within the technical scope disclosed in the present disclosures, which shall be covered by the scope of protection of the present disclosure. Therefore, the scope of protection of the present disclosure shall be determined by the scope of protection of the claims.

1. A metasurface unit, comprising:
a metal ground layer;
a liquid crystal layer disposed on the metal ground layer; and
one or more metal patches disposed on a side of the liquid crystal layer away from the metal ground layer and connected to a power supply via a bias line, wherein the one or more metal patches are rectangular, and have long sides extending in a same direction.

2. The metasurface unit of claim 1, wherein the metal ground layer and the one or more metal patches are configured as a reflector or scatterer of the metasurface unit to reflect or scatter an incident wave beam.

3. The metasurface unit of claim 1, wherein
the one or more metal patches have different sizes, and correspond to different operating frequency bands; and
each of the metal patches is configured to reflect or scatter an incident wave beam with a frequency belonging to an operating frequency band corresponding to the metal patch.

4. The metasurface unit of claim 3, wherein
the one or more metal patches have different lengths; or
the one or more metal patches have different widths.

5. The metasurface unit of claim 1, wherein the one or more metal patches comprise a first metal patch and a second metal patch, and the first metal patch and the second metal patch have different sizes.

6. The metasurface unit of claim 1, wherein a reflection or scattering amplitude and a reflection or scattering phase of the metasurface unit are continuously tunable through the liquid crystal layer, wherein
the reflection or scattering amplitude and the reflection or scattering phase of the metasurface unit to an incident wave beam are related to a dielectric constant of the liquid crystal layer, and the dielectric constant of the liquid crystal layer is related to a voltage of the power supply; and
the metasurface unit is configured to adjust the dielectric constant of the liquid crystal layer by adjusting the voltage of the power supply, and thus adjust the reflection or scattering amplitude and the reflection or scattering phase of the metasurface unit to the incident wave beam.

7. The metasurface unit of claim 1, wherein the metasurface unit further comprises:
a first substrate disposed on a side of the metal ground layer away from the liquid crystal layer; and
a second substrate disposed on a side of the one or more metal patches away from the liquid crystal layer.

8. The metasurface unit of claim 7, wherein the first substrate and the second substrate are made of glass.

9. A metasurface, comprising:
one or more metasurface units, each of which comprises:
a metal ground layer;
a liquid crystal layer disposed on the metal ground layer; and
one or more metal patches disposed on a side of the liquid crystal layer away from the metal ground layer and connected to a power supply via a bias line, wherein the one or more metal patches are rectangular, and have long sides extending in a same direction.

10. The metasurface of claim 9, wherein the one or more metasurface units are arranged in a matrix.

11. The metasurface of claim 9, wherein a deflection angle of a wave beam reflected and/or scattered by the metasurface is continuously adjustable,
wherein the deflection angle of the wave beam reflected or scattered by the metasurface is related to a phase period of the metasurface, and the phase period of the metasurface is related to dielectric constants of liquid crystal layers in the one or more metasurface units of the metasurface; and
the metasurface is configured to adjust the phase period of the metasurface by adjusting the dielectric constants of the liquid crystal layers in the one or more metasurface units of the metasurface, and thus adjust the deflection angle of the wave beam reflected or scattered by the metasurface.

12. The metasurface of claim 11, wherein the metasurface is further configured to adjust the phase period of the metasurface by adjusting dielectric constants of liquid crystal layers in a same column or row of the metasurface units to be the same and adjusting dielectric constants of liquid crystal layers in different rows or columns of the metasurface units to be different or the same.

13. The metasurface of claim 9, wherein the metal ground layer and the one or more metal patches are configured as a reflector or scatterer of the metasurface unit to reflect and/or scatter an incident wave beam.

14. The metasurface of claim 9, wherein
the one or more metal patches have different sizes, and correspond to different operating frequency bands; and
each of the metal patches is configured to reflect or scatter an incident wave beam with a frequency belonging to an operating frequency band corresponding to the metal patch.

15. The metasurface of claim 14, wherein
the one or more metal patches have different lengths; or
the one or more metal patches have different widths.

16. The metasurface of claim 9, wherein the one or more metal patches comprise a first metal patch and a second metal patch, and the first metal patch and the second metal patch have different sizes.

17. The metasurface of claim 9, wherein a reflection or scattering amplitude and a reflection or scattering phase of the metasurface unit are continuously tunable through the liquid crystal layer, wherein
the reflection or scattering amplitude and the reflection or scattering phase of the metasurface unit to an incident wave beam are related to a dielectric constant of the liquid crystal layer, and the dielectric constant of the liquid crystal layer is related to a voltage of the power supply; and
the metasurface unit is configured to adjust the dielectric constant of the liquid crystal layer by adjusting the voltage of the power supply, and thus adjust the reflection or scattering amplitude and the reflection or scattering phase of the metasurface unit to the incident wave beam.

18. The metasurface of claim 9, wherein the metasurface unit further comprises:
a first substrate disposed on a side of the metal ground layer away from the liquid crystal layer; and
a second substrate disposed on a side of the one or more metal patches away from the liquid crystal layer.

19. The metasurface of claim 18, wherein the first substrate and the second substrate are made of glass.
